(19) United States
(12) Patent Application Publication
(10) Pub. No.: US 2026/0359136 A1
(43) Pub. Date: Nov. 12, 2026

(54) Latency Reducing Micro-Service Orchestrator

(71) Applicant: PayPal, Inc., San Jose, CA (US)

(72) Inventor: Colin Sng, Round Rock, TX (US)

(21) Appl. No.: 19/201,653

(22) Filed: May 7, 2025

(51) Int. Cl. G06F 9/50

(52) U.S. Cl. CPC G06F 9/5061; G06F 2209/548

(57) ABSTRACT

Disclosed methods and systems include receiving a request from a client device by an orchestrator process of a task processing system that is executing on a server computer system. The orchestrator process may be configured to process the request at least in part by causing a plurality of computing tasks to be performed. The orchestrator process may distribute the computing tasks to a plurality of task queues and assign one or more compute resource pools to respective ones of the task queues. The computing tasks may include a query-response task in which a query portion is sent to a data store. The orchestrator process may receive, from the data store, a response to the query portion. The orchestrator process may add a response portion to a particular task queue of the plurality of task queues for subsequent processing by a particular compute resource pool associated with the particular task queue.

### BACKGROUND

### Technical Field

This disclosure relates generally to execution of online services, and more particularly to techniques for coordinating tasks associated with user actions on an online service.

### Description of the Related Art

When using online services, users may perceive latency in response to various actions performed. These services include, for example, account creation, risk analysis, search queries, and performing transactions. Performing a given action may cause a series of tasks to be performed, many of which are performed in sequence. For example, an account creation may trigger tasks such as identity checks and risk assessments of the account requestor, validation of information provided by the requestor (address, email, telephone numbers), and establishing a link to other online accounts of the requestor (e.g., social media, professional accounts, and the like). Many of the tasks may include one or more query-response sub-tasks in which the online service sends a query, e.g., to a third-party database, and awaits a response, such as a validation of the requestor's personal information. For example, a risk assessment may include one or more query response tasks that request information about the requestor from one or more personal accounts associated with the requestor in order to determine if the requestor is who they say they are. The online servers may be structured such that a computing resource that initiates a query also waits for the corresponding response.

### BRIEF DESCRIPTION OF THE DRAWINGS

FIG. 1 is a block diagram illustrating an embodiment of a system that may use disclosed techniques to perform an action requested by a client device.

FIG. 2 shows a block diagram of the embodiment of the system of FIG. 1 at a later point in time.

FIG. 3 depicts a block diagram of another embodiment of the system of FIG. 1 performing a plurality of database tasks associated with a particular action.

FIG, 4 illustrates a block diagram of another embodiment of the system of FIG. 1 allocating resource pools to different types of clients.

FIG. 5 shows a flow diagram of an embodiment of a method for performing an action requested by a client device.

FIG. 6 depicts a flow diagram of an embodiment of a method for performing a query-response task.

FIG. 7 illustrates a flow diagram of an embodiment of a method for organizing and performing a plurality of database tasks.

FIG. 8 shows a flow diagram of an embodiment of a method for allocating resource pools to different types of clients.

FIG. 9 is a block diagram illustrating an example computer system, according to some embodiments.

### DETAILED DESCRIPTION

An online server provider may desire to provide users of the service responses to their actions within a particular amount of time. Such a response time may be referred to as a “quality of service,” or “QoS” for short. As disclosed above, actions that are requested by users may be broken into a plurality of tasks. For example, an orchestrator process may be performed by a server computer system to receive actions requested by a client device and then divide the requested action into the plurality of tasks. Such an orchestrator may then assign the plurality of tasks to one or more task queues to allow different ones of a plurality of compute resources to perform the different tasks in an overlapping manner where appropriate. In the case of query-response tasks, typical known orchestrators assign a single compute resource to perform the initial query portion and follow through with any sub-tasks associated with a received response to the query. The assigned resource may, therefore, be unavailable for performing other tasks until all sub-tasks associated with the query-response task are completed.

Furthermore, many such query-response tasks include issuing a query to a third-party database. In some instances, multiple queries may be made to a given third-party database, and these queries may be performed independently of one another. In some cases, each query to a third-party database may include a respective authorization sub-task to validate that the requestor is authorized to access data associated with the query. Accordingly, performing such tasks independent independently may result in numerous authorization sub-tasks being performed.

The present disclosure recognizes that a novel microservice orchestrator may be implemented that allows requested actions to be divided into tasks that may be performed with an increased degree of parallelism. For example, query-response tasks may be assigned to resources such that a first resources performs the query portion and then proceeds to a next task in a task queue, allowing a different resource to receive the subsequent response and complete the query-response task. In addition, complexity behind multiple database queries may be simplified to reduce an overall execution time. For example, a plurality of calls to a given database may be combined into a fewer number of calls that request larger amounts of data.

Disclosed embodiments include a technique in which a server computer system executes instructions of an orchestrator process that receives a request from a client device. The orchestrator process may divide the request into a plurality of tasks which may then be distributed to a plurality of task queues. Additionally, the orchestrator process may assign one or more compute resource pools to respective ones of the plurality of task queues. A given compute resource pool may include processing circuitry and memory configured to perform task processing, including processing a query portion of a query-response task in which the query portion of the query-response task is sent to a data store. The orchestrator process may receive, from the data store, a response to the query portion. After receiving the response, the orchestrator process may add a response portion of the query-response task to a particular task queue of the plurality of task queues for subsequent processing by a particular compute resource pool associated with the particular task queue.

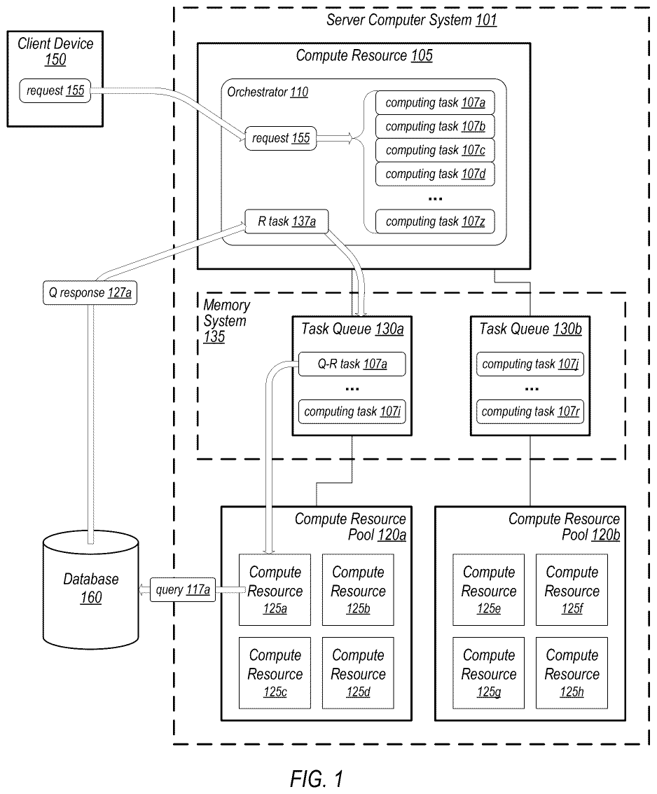

A block diagram of an embodiment of a system that may be used to implement the disclosed techniques is illustrated in FIG. 1. As illustrated, elements of system 100 include server computer system 101, client device 150 and database 160. Server computer system 101 includes compute resource 105, memory system 135, and compute resource pools 120a and 120b (collectively 120). Memory system 135 includes task queues 130a and 130b (collectively 130), which may be comprised of any suitable combination of volatile and/or nonvolatile memory circuits, e.g., dynamic random-access memory (DRAM), static RAM (SRAM), hard-drives, solid-state drives, and the like. Compute resource pools 120 further include compute resources 125a-125d and 125e-125h, respectively (collectively, compute resources 125). Ones of compute resources 105 and 125, in various embodiments, may be implemented as a single computer (e.g., a desktop computer, laptop computer, server computer), or a plurality of computers located in a single location or distributed across multiple locations. In some embodiments, compute resources 105 and/or 125 may be implemented using a virtual machine hosted by one or more server computer systems. Accordingly, ones of compute resources 105 and 125 include one or more central processing units (CPUs) capable of executing instructions of one or more different instruction set architectures. Client device 150 and/or database 160 may be implemented in a similar manner as compute resources 105 and/or 125. Compute resources 105 and 125, in some embodiments, may be coupled directly to one another. In other embodiments, compute resources 105 and 125 may be linked to one another via a local area network (LAN) and/or a wide area network (e.g., the internet).

As illustrated, compute resource 105 may be configured to execute program instructions of orchestrator 110, which may be stored in memory system 135. Orchestrator 110 may cause one or more processors of compute resource 105 to receive request 155 from client device 150. Processing request 155 may include performing a plurality of computing tasks 107a-107z (collectively 107). Orchestrator 110 may determine computing tasks 107 for performing request 155 received from client device 150, including determining that at least computing task 107a is a query-response task that includes a request for information from database 160. Orchestrator 110 may distribute computing tasks 107 to a plurality of task queues, including task queues 130a and 130b which are stored in memory system 135. In various embodiments, a task queue 130 may be implemented as a storage circuit (e.g., a plurality of registers configured to hold information related to ones of computing tasks 107), as a data structure stored in one or more memory circuits, such as a system RAM, and the like. As shown, this distribution includes placing query-response task 107a in task queue 130a.

Orchestrator 110 may assign ones of the plurality of compute resources 125 to respective ones of the plurality of task queues 130. As illustrated, compute resources 125 are grouped into a plurality of compute resource pools 120. Such resource pools may include ones of compute resources 125 that are located in a same physical space (e.g., a same server room, a same server rack, a same server blade, and the like). Orchestrator 110 may assign one or more of compute resource pools 120 to ones of task queues 130, wherein compute resources 125 of an assigned compute resource pool 120 are configured to perform the computing tasks placed into the corresponding task queue 130.

As illustrated, compute resource 125a of compute resource pool 120a retrieves query-response task 107a from task queue 130a. Compute resource 125a may determine that query-response task 107a includes a call to database 160, which, in some embodiments, may be operated by a third-party. Accordingly, a response from database 160 may be expected to take a large enough amount of time that compute resource 125a issues query 117a as a query portion of query-response task 107a. Based on completing query 117a of query-response task 107a, compute resource 125a may retrieve a next computing task from task queue 130a rather than waiting for query response 127a from database 160.

Database 160, after receiving query 117a, sends query response 127a to server computer system 101 where it is received by orchestrator 110. Orchestrator 110 may then create a new response task 137a based on query response 127a and add response task 137a of query-response task 107a to a given one of task queues 130 (task queue 130a, as shown). In some embodiments, adding response task 137a to task queue 130a includes adding response task 137a to a top of task queue 130a, thereby enabling response task 137a to be the next computing task picked from task queue 130a.

Use of such techniques may reduce an amount of time to perform computing tasks relater to a requested client action. Reducing the amount of time may improve a QoS for performing such actions, thereby reducing or eliminating a need for adding compute resources to maintain a particular QoS level. Throughput of actions performed by the server computer system may increase, allowing the server computer system to provide services to a greater number of clients.

It is noted that the embodiment of FIG. 1 is merely an example. Features of the system have been simplified for clarity. In other embodiments, additional elements may be included, such as networking circuits to couple compute resources 125 to database 160 and plurality of client devices. As shown, each task queue 130 is assigned one compute resource pool 120. In other embodiments, two or more compute resource pools 120 may be assigned to a single task queue 130. Although two task queues and two compute resource pools are shown, any suitable number of each may be included in other embodiments. Orchestrator 110 may, in some embodiments, be implemented as a non-transitory computer-readable medium having instructions stored thereon that are executable by a computing device (e.g., compute resource 105) to perform the disclosed operations.

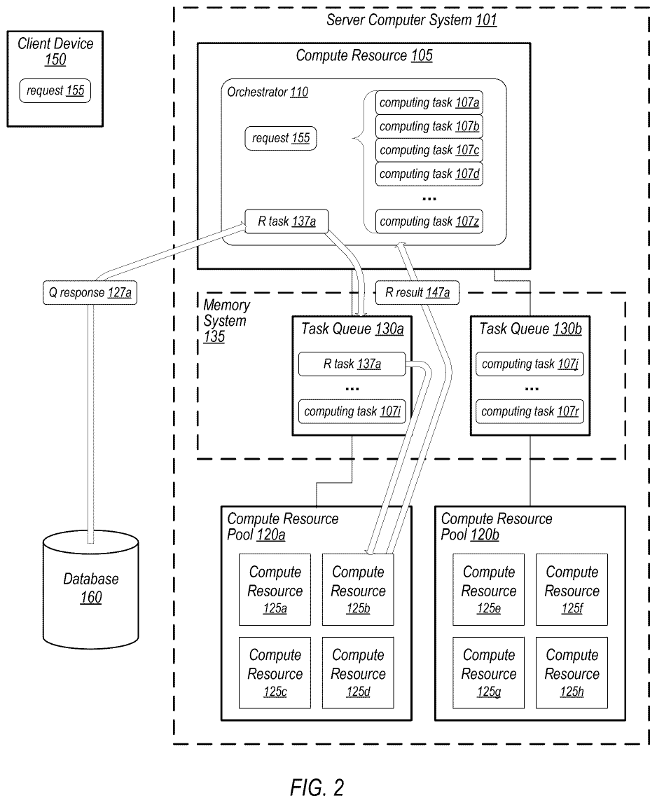

In the embodiment of FIG. 1, techniques for efficiently managing computing tasks to be performed to complete a requested action are disclosed. Further optimizations are contemplated and disclosed below. For example, FIG. 1 illustrated creating a new response task for completing a response portion of a query-response task. A technique for processing the new response task is contemplated in FIG. 2.

Proceeding to FIG. 2, system 100 of FIG. 1 is shown is shown at a later point in time after a response to a query has been received by orchestrator 110. As illustrated, system 100 is depicted as having generated response task 137a after receiving query response 127a as disclosed above. Orchestrator 110 places response task 137a in task queue 130a. In the illustrated embodiment, response task 137a is added to the top of task queue 130a to reduce an amount of time until response task 137a is picked from task queue 130a. Although response task 137a is placed in the same task queue 130a as the original query-response task 107a, orchestrator 110 may, in other embodiments, place response task 137a into any suitable one of the plurality of task queues 130. Orchestrator 110 may utilize any suitable arbitration technique to select one of task queues 130 into which the created response task 137a is placed. For example, a round-robin technique may be used, a least recently used task queue 130 may be selected, a task queue 130 with the least number of computing tasks in queue may be selected, or so forth.

As shown, computer resource 125b retrieves response task 137a from task queue 130a. Although in the same compute resource pool 120a as compute resource 125a, compute resource 125b is different from compute resource 125a that processed the query portion of the original query-response task 107a. In other cases, task queue 130b may be selected for placing response task 137a, thereby enabling a compute resource from compute resource pool 120b to retrieve response task 137a. Compute resource 125b may complete query-response task 107a by performing response task 137a.

Meanwhile, compute resource 125a may, after performing query 117a, as described above, perform, independent of query-response task 107a, the next computing task from task queue 130a (e.g. computing task 107c. Compute resource 125a may be busy performing computing task 107c, or a subsequent computing task 107, when response task 137a is placed into task queue 130a, thereby preventing compute resource 125a from retrieving response task 137a from task queue 130a. Orchestrator 110 may be configured to receive an indication that compute resource 125b processed response task 137a, thereby completing performance of query-response task 107a.

By allowing a first compute resource to perform the query portion of the query-response task and then proceed to an unrelated computing task while a second compute resource completes the response portion of the query-response task, a query-response task that takes longer to complete than other computing tasks may be performed while consuming less compute resource processing bandwidth. Such a reduction of processing bandwidth may allow a server computer system to perform more efficiently and improve a quality of service without a need for additional hardware compute resources.

It is noted that the embodiment of FIG. 2 is merely an example. Although only one query-response task is shown in FIGS. 1 and 2, a given request from a client device may include a plurality of such tasks. Accordingly, reduction of processing bandwidth for these query-response tasks may result in a non-trivial improvement in reducing an overall response time to the given request. As previously disclosed, although two task queues with respective compute resource pools assigned are shown, any suitable number of task queues may be used, each task queue being allocated a suitable number of compute resource pools.

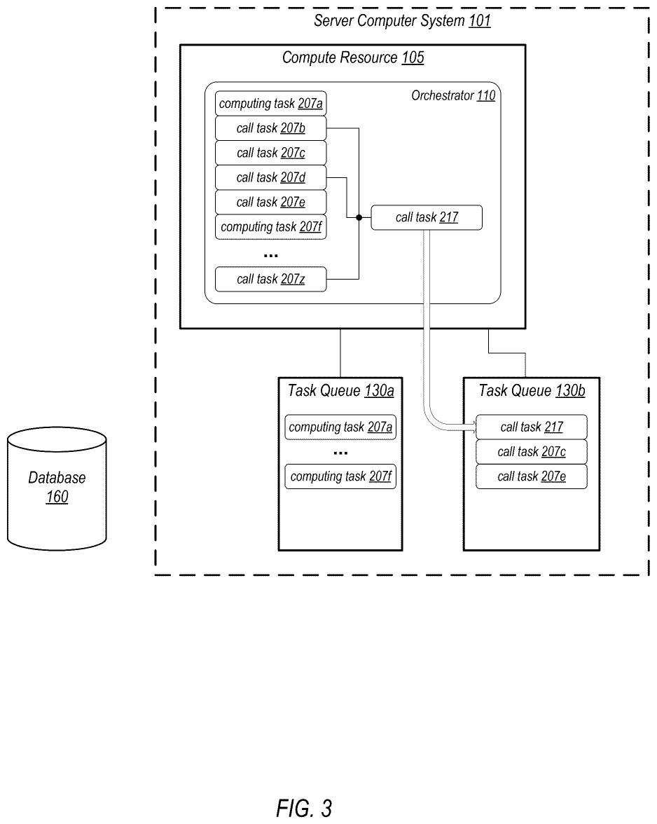

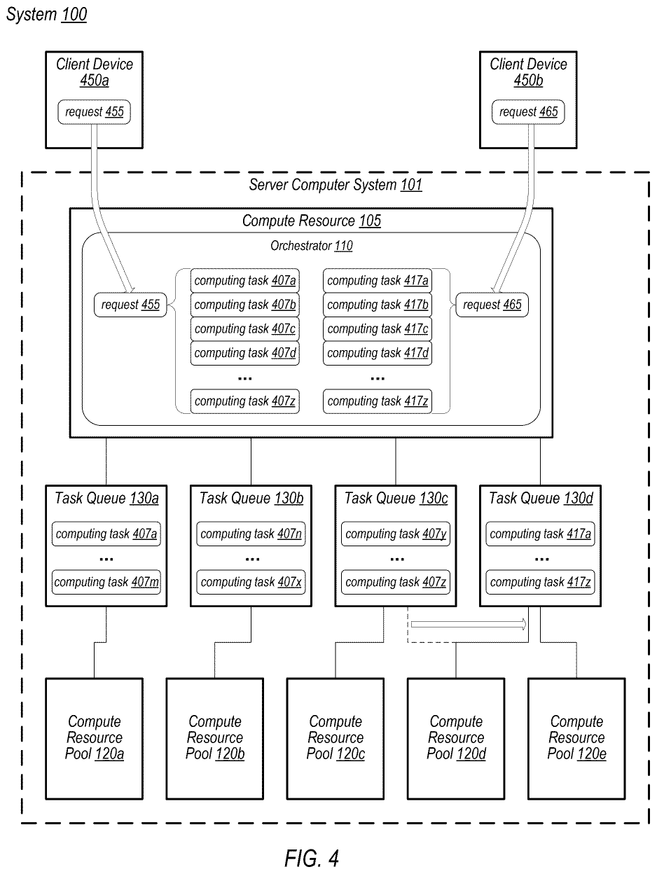

In FIGS. 1 and 2, a technique is described for processing a query-response task along with a plurality of other computing tasks. Other techniques for increasing a quality of service are contemplated. An example of a computer system in which database tasks are grouped to increase efficiency is depicted in FIG. 3.

Moving to FIG. 3, another block diagram of system 100 from FIGS. 1 and 2 is depicted. As illustrated in FIG. 3, system 100 orchestrator 110 has received one or more requests that include a plurality of computing tasks 207a-207z (collectively computing tasks 207). A portion of computing tasks 207 include calls to a particular database. Call tasks 207b-207e and 207z are respective computing tasks 207 that include a respective call to database 160. For example, a particular request, such as a request to execute a transaction between two entities may require retrieval of a variety of information regarding the two entities. In some cases, identity may be validated for both entities prior to executing the transaction to mitigate a risk of a fraudulent action. In addition, assets to fulfil each entity's portion of the transaction may be verified. Database 160 may include a variety of information that is usable for server computer system 101 to perform these validations prior to executing the transaction.

To distribute the plurality of computing tasks 207 to task queues 130, orchestrator 110 may be configured to identify a plurality of call tasks that are calls to a common database. As stated, call tasks 207b-207e and 207z (collectively call tasks 207) are respective computing tasks that include a respective call to database 160. After determining that call tasks 207 each issue a respective query to database 160, orchestrator 110 may place at least a portion of the plurality of call tasks 207 into a common one of the plurality of task queues. For example, orchestrator 110 places call task 207c and 207e into task queue 130b.

In addition, to place the at least a portion of the plurality of call tasks 207 into task queue 130b, orchestrator 110 may be further configured to combine at least two of the identified call tasks 207 into a single call task. As shown, orchestrator 110 combines call tasks 207b, 207d, and 207z into call task 217. For example, call tasks 207b, 207d, and 207z may include queries for different information related to a particular one of the two entities. Call tasks 207b, 207d, and 207z, therefore, may be combined into a single call task 217 which, in turn, orchestrator 110 may place into task queue 130b along with the other call tasks 207c and 207e.

Combining call tasks 207b, 207d, and 207z into the single call task 217 may reduce an amount of communication between database 160 and server computer system 101. In addition, access to database 160 may be restricted and, therefore, require an authorization step prior to retrieving any information. By combining several call tasks into a single call task, a corresponding single authorization step may be performed rather than a respective authorization step for each call task. In some cases, a single authorization step may be performed for a series of call tasks from a common compute resource or even a common compute resource pool. Accordingly, placing call tasks 207c and 207e with call task 217 may allow all three call tasks to be authorized with a single authorization step.

It is noted that FIG. 3 is one example of a computer system capable of identifying and combining call tasks to a common database. The embodiment of FIG. 3. is simplified for clarity. Although not shown, compute resource pools (e.g., compute resource pools 120) are included to retrieve and perform the computing tasks placed into task queues 130. Although a single combined call task is created in the illustrated embodiment, a plurality of call tasks may be combined into any suitable number of unified call tasks, including a respective unified call task for respective ones of a plurality of databases.

The embodiments of FIGS. 1-3 disclose processing one request received from a given client device. A sever computer system may, however, receive a plurality of requests from a plurality of client devices. FIG. 4 shows the server computer system of FIGS. 1-3 organizing and performing computing tasks from a plurality of client devices.

Proceeding to FIG. 4, another block diagram of system 100 is illustrated. As depicted, system 100 includes client devices 450a and 450b issuing respective requests to server computer system 101. Client devices 450a and 450b may be implemented in a similar manner as described above for client device 150. Client devices 450a and 450b may, however, be associated with different types of clients. For example, client device 450a may be operated by a business client that has a first type of account for accessing server computer system 101, while client device 450b is operated by a client with a personal account. Server computer system 101 may process requests received from business accounts different from requests received from personal accounts. For example, business accounts may be processed in accordance to a quality of service that guarantees lower response times to requests than response times guaranteed for personal accounts.

As shown, orchestrator 110 may be configured to assign ones of the compute resource pools 120 to respective ones of the plurality of task queues 130 in a manner that supports different tiers of QoS, such as a first tier that includes business accounts and a second tier that includes personal accounts. In the illustrated embodiment, the first tier may have a higher QoS level that guarantees a lower response time for completing requested actions, such as request 455, in comparison to a QoS level associated with the second tier requested actions, such as request 465.

Orchestrator 110 may be configured to receive request 455 via client device 450a that is associated with a first-tier account. Orchestrator 110 may divide request 455 into computing tasks 407a-407z which are then placed into ones of a subset of task queues 130 (e.g., task queues 130a-130c). A first set of the compute resource pools (120a-120d) may be allocated to a first subset of the plurality of task queues (e.g., 130a-130c). Accordingly, compute resource pools 120a-120d are associated with clients having business accounts.

In a similar manner, orchestrator 110 may also be configured to receive request 465 via client device 450b that is associated with a second-tier account. Orchestrator 110 may divide request 465 into computing tasks 417a-417z which are then placed into a subset of task queues 130 (e.g., task queue 130d). A second set of the compute resource pools (e.g., 120e) may be allocated to a second subset of task queues (e.g., 130d). Compute resource pool 120e, therefore, is associated with clients having personal accounts.

A business account may be expected to generate more requests than a personal account. Accordingly, guaranteeing a higher QoS for business accounts may reduce an overall amount of time that client device 450a spends waiting for these requests to be completed, thereby increasing the business client's satisfaction with server computer system 101. A personal client associated with client device 450b, in contrast, may not generate as many requests, and therefore, reducing a response time for request 465 may not result in a same overall amount of response time savings. For example, saving one-half second on average over 1000 business requests may reduce overall QoS response times as compared to saving two seconds on average over five personal requests.

Although the second-tier accounts may have lower QoS levels, orchestrator 110 may still determine whether the lower QoS level associated with the second tier is being met. For example, orchestrator 110 may be configured to compare a number of computing tasks 407 in task queues 130a-130c to a number of computing tasks 417 in task queue 130d. If, for example, a number of computing tasks 407 waiting in task queues 130a-130c is less than the number of computing tasks 417 waiting in task queue 130d by a threshold amount, then orchestrator 110 may attempt to balance the compute resource pool allocation to, at least temporarily, reduce an amount of time for processing computing tasks 417. To balance the allocation, orchestrator 110 may be configured to reallocate, based on the comparison, compute resource pools 120 between the first and second sets of task queues 130. As shown, for example, compute resource pool 120d is reassigned from task queue 130c of the first tier to task queue 130d of the second tier.

Under other conditions, the comparing may identify that a difference between a number of computing tasks 407 and a number of computing tasks 417 is below the threshold or satisfies a different threshold such that orchestrator 110 is further configured to reallocate one or more compute resource pools 120 from task queue 130d to one of task queues 130a-130c to prioritize the first-tier accounts.

It is noted that the example of FIG. 4 is merely for demonstrative purposes. For clarity, only elements for illustrating the disclosed concepts are shown. Only four task queues and five compute resource pools are shown. Other embodiments may include any suitable number of task queues and compute resource pools. While compute resources are illustrated as being organized and allocated by pools, in other embodiments, individual compute resources may be reallocated, including from one resource pool into another. It is contemplated that the techniques of FIGS. 1-4 may be combined in any suitable manner.

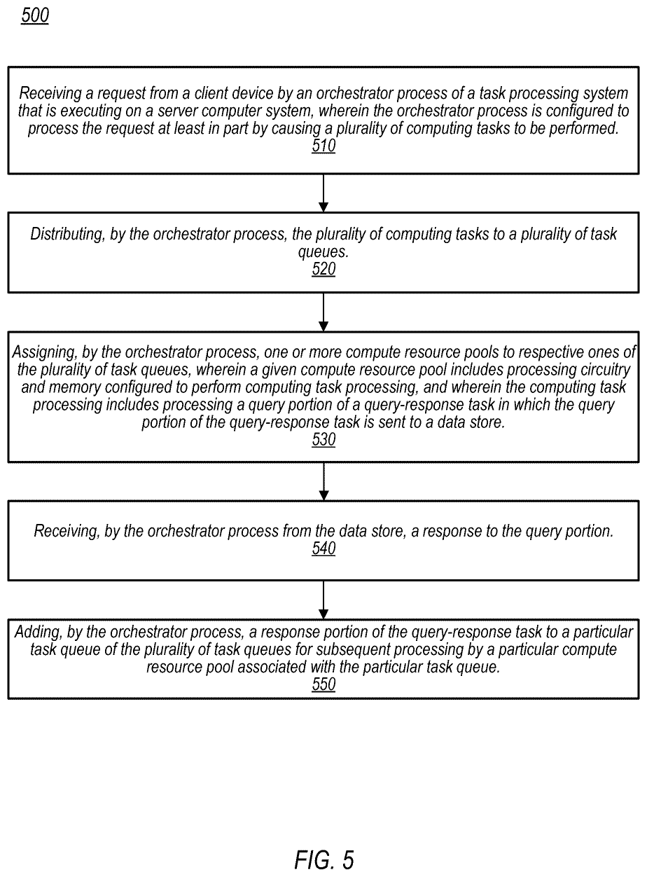

FIGS. 1-4 depict systems for receiving, organizing, and processing client requests using a plurality of compute resources. These systems may employ a variety of methods for implementing these capabilities. For example, server computer system 101 may include or be coupled to a non-transitory computer-readable medium that has instructions stored thereon that are executable by compute resource 105 to perform some or all of the operations described herein. The following FIGS. 5-8 illustrate examples of such methods.

Moving now to FIG. 5, a flow diagram of an embodiment of a method for processing a request from a client device is depicted. In various embodiments, method 500 may be performed by a computer system such as compute resource 105 in FIGS. 1-4. Method 500 is described below using system 100 of FIG. 1 as an example. References to elements in FIG. 1 are included as non-limiting examples.

At block 510, method 500 begins with a server computer system receiving a request from a client device by an orchestrator process of a task processing system that is executing on the server computer system. As illustrated, server computer system 101 utilizes compute resource 105 to perform operations associated with orchestrator 110, including receiving and processing request 155 from client device 150. Orchestrator 110 may be configured to process request 155 at least in part by causing a plurality of computing tasks 107 to be scheduled and performed. In various embodiments, orchestrator 110 may be implemented entirely in software executed by compute resource 105, entirely by hardware included in or coupled to compute resource 105, or a combination thereof.

Method 500 proceeds to block 520 with the computer system distributing, via the orchestrator process, the plurality of computing tasks to a plurality of task queues. As described above, orchestrator 110 may be configured to distribute computing tasks 107 among task queues 130b. Although two task queues 130 are shown, any suitable number of task queues may be included and used for placing ones of computing tasks 107. Computing tasks 107 may be distributed using any suitable technique. For example, ones of computing tasks 107 that are dependent on performance of a different computing task, may grouped in a same task queue 130 to help prevent the dependent computing task from being performed (or attempted to be performed) prior to the computing task from which it depends. Accordingly, ones of computing tasks 107 that may be performed independently of one another, may be distributed to different task queues such that concurrent performance of computing tasks 107 may be enabled where applicable.

Method 500 continues at block 530 with the computer system assigning, by the orchestrator process, one or more compute resource pools to respective ones of the plurality of task queues. Orchestrator 110 may assign one or more of compute resource pools 120 to each of task queues 130. In some embodiments, one or more of task queues 130 may be assigned a plurality of compute resource pools 120 while other task queues 130 may not be assigned, at least temporarily, one of compute resource pools 120. A given compute resource pool 120 includes processing circuitry and memory (e.g., respective ones of compute resources 125) usable to perform computing task processing. The computing task processing for request 155 includes processing query-response task 107a with a query portion and a response portion, in which the query portion is sent to a data store (e.g., database 160).

At block 540, method 500 proceeds with the computer system receiving, by the orchestrator process from the data store, a response to the query portion. Orchestrator 110 may receive query response 127a from database 160. As shown, compute resource 125a sends query 117a to database 160, query 117a including a request for information that is stored in database 160 and is usable for completing request 155. Query-response task 107a may, for example, be part of a risk assessment operation and include identifying recent activity associated with client device 150 and then analyzing any identified activity to determine whether client device 150 has recently been involved with questionable activity. Query 117a may, therefore, requests the information associated with client device 150.

Method 500, at block 550, continues with the computer system adding, by the orchestrator process, a response portion of the query-response task to a particular task queue of the plurality of task queues for subsequent processing by a particular compute resource pool associated with the particular task queue. Continuing the risk assessment example, orchestrator 110 may receive query response 127a from database 160, with query response 127a including details regarding one or more actions that have been previously associated with client device 150. Orchestrator 110 may then create one or more computing tasks (e.g., response task 137a) to process the results included in query response 127a and then place response task 137a into one of task queues 130 (130a as shown in FIG. 1). In some embodiments, adding response task 137a to task queue 130a includes adding, by orchestrator 110, response task 137a to a top of task queue 130a. Placement of response task 137a to a top of task queue 130a may reduce an amount of time for response task 137a to be retrieved and processed by a given compute resource 125 in compute resource pool 120a.

Use of method 500 may reduce an amount of time for processing computing tasks associated with a given request by, for example, enabling concurrent processing of at least a portion of the associated computing tasks. Furthermore, splitting a query-response task into one or more portions that may be processed by different ones of a plurality of compute resources may further increase operational efficiency and reduce an overall amount of time for responding to request 155.

It is noted that the method of FIG. 5 includes blocks 510-550. Method 500 may end in block 550 or may repeat some or all of blocks 510-550 for processing the request. For example, blocks 530-550 may be repeated in response to the request from the client device including more than one query-response task. In some cases, method 500 may be performed concurrently with other instances of the method. For example, orchestrator 110 may receive two or more requests and then concurrently assign a respective plurality of computing tasks for each requests.

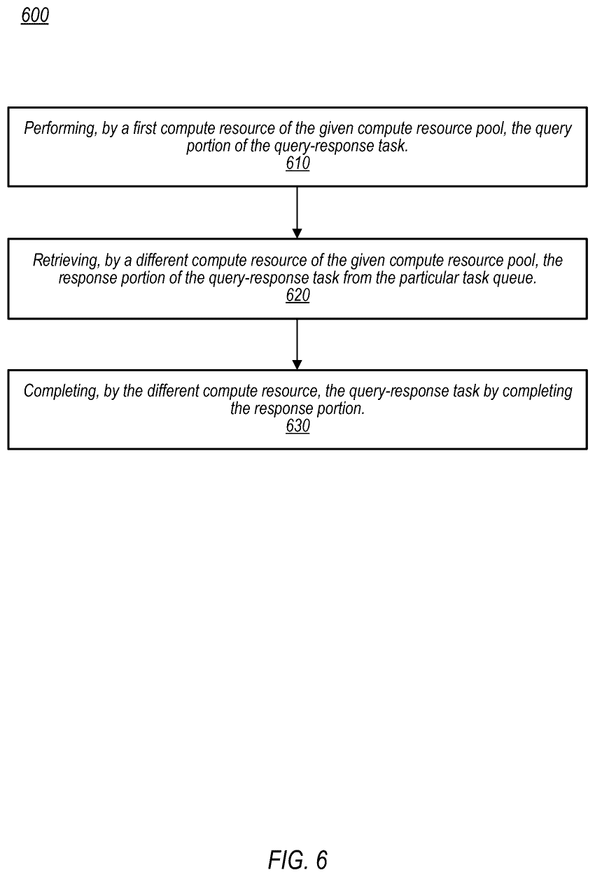

Moving to FIG. 6, a flow diagram of an embodiment of a method for performing a query-response task using two different compute resources is depicted. Method 600 may be performed by a computer system such as one or more of compute resources 125 in server computer systems 101 in FIGS. 1-4. In some embodiments, portions or all of method 600 may correspond to one or more actions that occur, for example, as a part of blocks 530 to 550 in method 500. Method 600 is described below using FIGS. 1 and 2 as examples. References to elements in FIGS. 1 and 2 are included as non-limiting examples. Operations of method 600 may begin after block 530 of method 500 has been performed, e.g., after orchestrator 110 has placed a query portion of query-response task 107a into task queue 130a.

At block 610, method 600 begins with a first compute resource of a given compute resource pool performing the query portion of the query-response task 107a. For example, compute resource 125a of compute resource pool 120a retrieves query-response task 107a and performs the query portion by issuing query 117a to database 160. In some embodiments, orchestrator may include only the query portion of query-response task 107a in task queue 130a. In other embodiments, orchestrator 110 may place the entire query-response task 107a in task queue 130a and compute resource 125a may determine to issue query 117a to database 160. In such embodiments, compute resource 125a may then send an indication to orchestrator 110 that only the query portion of query-response task 107a is being processed and the response portion needs to be reassigned as a subsequent computing task.

Method 600 may continue to block 620 with a second compute resource of the given compute resource pool retrieving a response portion of query-response task 107a from the particular task queue. As described above in regard to method 500, orchestrator 110 may determine that only the query portion of query-response task 107a has been processed and, based on receiving query response 127a, creates and places response task 137a into task queue 130a as shown in FIG. 2. Compute resource 125b retrieves response task 137a from task queue 130a and performs the associated computing task.

Method 600 may proceed to block 630 with the different compute resource completing query-response task 107a by completing the response portion. Response task 137a may include one or more steps to complete. Compute resource 125b performs the associated steps and after all steps have been completed, may send an indication to orchestrator 110 to indicate that response task 137a has been performed. Orchestrator 110 may, based on receiving the indication, identify query-response task 107a as being performed. In some embodiments, orchestrator 110 may have a queue of additional computing tasks (which may be related to request 155, or to a different computing task from client device 150 or from another client device, not shown).

It is noted that the method of FIG. 6 includes blocks 610-630. Method 600 may end in block 630. Some or all of the operations may be repeated in response to submission of a subsequent client request that also includes performing a query-response task. In a similar manner to method 500, different instances of method 600 may be performed concurrently for different requests or different query-response tasks in a same request. Method 600 may be performed concurrently with (or as a part of) method 500.

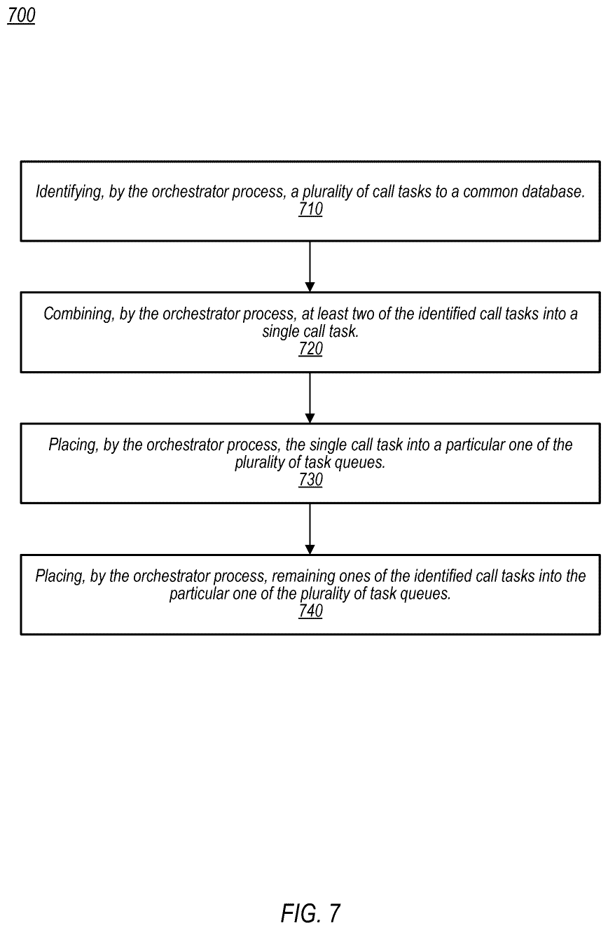

Moving to FIG. 7, a flow diagram of another embodiment of a method for performing a search query that includes a selected tab with secure information is illustrated. In a similar manner to methods 500 and 600, method 700 may be performed by a computer system such as server computer system 101, and more specifically, compute resource 105 in FIGS. 1-4. Method 700 is described below using system 100 in FIG. 3 as an example. In some embodiments, operations of method 700 may be performed as part of block 520 of method 500, e.g., as part of the distribution of computing tasks 107 into task queues 130. References to elements in FIG. 3 are included as non-limiting examples. Operations of method 700 may begin in block 710.

At block 710, method 700 begins with an orchestrator process of a server computer system identifying a plurality of call tasks to a common database. For example, after determining a plurality of computing tasks 207 for performing a received request, orchestrator 110 may be configured to analyze computing tasks 207 to identify tasks that include a call to one or more databases, and in particular, calls to third-party databases. As disclosed above, call tasks to a third-party database may include an authorization step in order to gain access to information stored in the third-party database. In addition, response times for a call to a third-party database may be long due to network traffic, available bandwidth of the third-party database, and so forth.

Further operation of method 700 may continue in block 720 with the orchestrator process combining at least two of the identified call tasks into a single call task. As shown in FIG. 3, orchestrator 110 identifies call tasks 207b-207e and 207z that all include a call to database 160. Database 160 may store a wide variety of information and, in some embodiments, may not be able to access all desired information in a single call. In the present example, orchestrator 110 identifies call tasks 207b, 207d, and 207z as being suitable for combining and creates a new call task, combining these call tasks into a single call task 217.

Method 700 may proceed to block 730 with the orchestrator process placing the single call task into a particular one of the plurality of task queues. After identifying ones of computing tasks 207 that include call tasks and creating call task 217, orchestrator 110 may place call task 217 into task queue 130b. Although shown at the top of task queue 130b, call task 217 may be placed into any suitable entry in task queue 130b.

Method 700 may continue at block 740 with the orchestrator process placing remaining ones of the identified call tasks into a particular one of the plurality of task queues. As shown in FIG. 3, call tasks 207c and 207e are not combined with any other identified call tasks and, therefore, may be placed into task queues as standalone call tasks. A given call task may not be combined if it requires a different authentication than other call tasks, if the requested information is related to a different subject than the other call tasks, and other similar reasons. Despite not being combined with other call tasks, orchestrator 110 may place call tasks 207c and 207e in task queue 130b along with call task 217. Response time, in some embodiments, may be reduced if a series of database calls are issued from a same compute resource and/or compute resource pool. For example, a given compute resource or pool of compute resources may establish a communication channel with database 160, thereby reducing traffic/bandwidth issues that may delay responses from database 160.

It is noted that the method of FIG. 7 includes blocks 710-740. Method 700 may end in block 740. In some cases, some, or all, of the operations may be repeated in response to identifying a set of call tasks to a different database. In a similar manner to methods 500 and 600, different instances of method 700 may be performed concurrently to combine and distribute call tasks for the different databases. Method 700 may also be performed concurrently with methods 500 and 600.

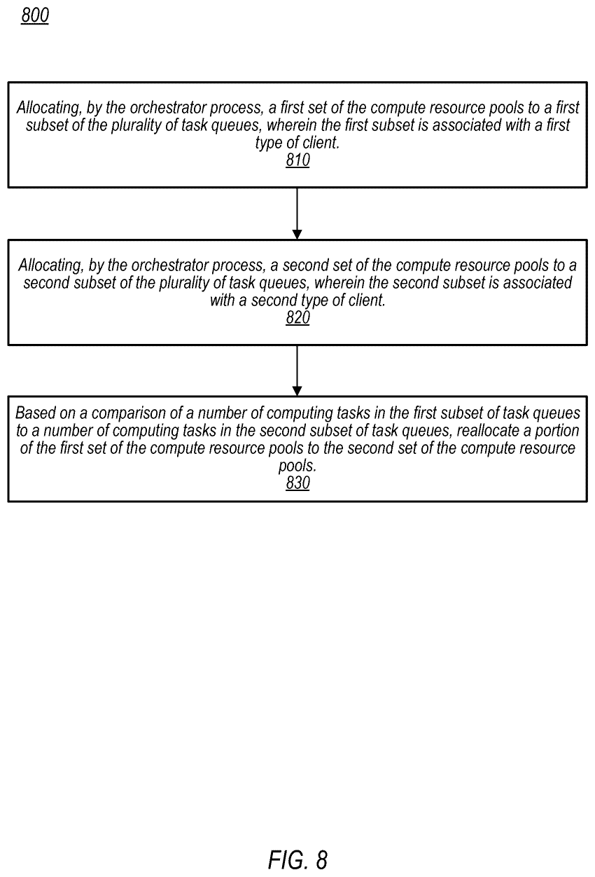

Moving to FIG. 8, a flow diagram of an embodiment of a method for distributing computing tasks for different tiers of clients is shown. Method 800 may be performed by a computer system such as one or more of the compute resources of server computer system 101 (e.g., compute resource 105) in FIGS. 1-4. Method 800 is described below using FIG. 4 as an example. References to elements in FIG. 4 are included as non-limiting examples. Operations of method 800 may begin in block 810.

At block 810, method 800 begins with an orchestrator process of a server computer system allocating a first set of the compute resource pools to a first subset of the plurality of task queues. As described above, services provided by server computer system may include a plurality of tiers of services, e.g., related to different guarantees of QoS. A higher level of QoS (e.g., less latency in responses to requests) may have a higher cost than a lower level of QoS (e.g., more latency). In the illustrated embodiment, client device 150a is associated with a first type of client (e.g., a first-tier QoS). Orchestrator 110 receives request 455 from client device 150a and generates computing tasks 407a-407z. Orchestrator 110 may then distribute computing tasks 407 across task queues 130a-130c. This first subset of task queues 130a-130c may be associated with the first type of clients. Task queues 130a and 130b are each allocated a compute resource pool (120a and 120b, respectively). Task queue 130c is allocated two compute resource pools (120c and 120d).

Method 800 may continue to block 820 with the orchestrator process allocating, by the orchestrator process, a second set of the compute resource pools to a second subset of the plurality of task queues. In a similar manner as described for the first tier, orchestrator 110 receives request 465 from client device 150b, which is associated with a second type of client (e.g., second-tier QoS). Orchestrator 110 may generate computing tasks 417a-417z for performing request 465 and then placing computing tasks 417 in task queue 130d. This second subset that includes task queue 130d may be associated with the second type of clients. Task queue 130d is allocated compute resource pool 120e.

Method 800 may proceed to block 830 with the orchestrator process, based on a comparison of a number of computing tasks in the first subset of task queues to a number of computing tasks in the second subset of task queues, reallocating, by the orchestrator process, a portion of the first set of the compute resource pools to the second set of the compute resource pools. Due to the higher QoS for the first-tier clients, computing tasks 407 for request 455 may be processed faster than computing tasks 417 for request 465. Orchestrator 110 may monitor entries in each of task queues 130 to look for instances of one or more task queues filling up more rapidly and/or not completing allocated computing tasks in a threshold amount of time. In some embodiments, orchestrator 110 may determine current QoS level being provided by the different subsets of task queues. If, for example, requests associated with the computing tasks 417 in task queue 130d are not performed in accordance with the QoS level corresponding to the second tier, then orchestrator 110 may redistribute compute resource pools 120 to move one or more available compute resource pools 120 (e.g., compute resource pool 120d) to task queue 130d to reduce latency for performing computing tasks 417. After requests allocated to task queue 130d are determined to be performed in accordance with the second-tier QoS, then orchestrator 110 may reassign compute resource pool 120d back to task queue 130c, or to another task queue that is associated with requests not performed in accordance with their respective QoS level.

It is noted that the method of FIG. 8 includes blocks 810-830. Method 800 may end in block 830 or may end in block 820 if no compute resource pools are reallocated. In some cases, some, or all, of the operations may be repeated periodically to continuously look for issues with meeting respective QoS levels. In other cases, at least some of the operations may be repeated in response to one or more task queues reaching a threshold number of unavailable entries. For example, method 800 may be repeated in response to task queue 130d reaching a minimum number of available entries. In a similar manner as for the other methods, different instances of method 800 may be performed concurrently for different sets of task queues. Method 800 may be performed concurrently with (or as a part of) the other disclosed methods.

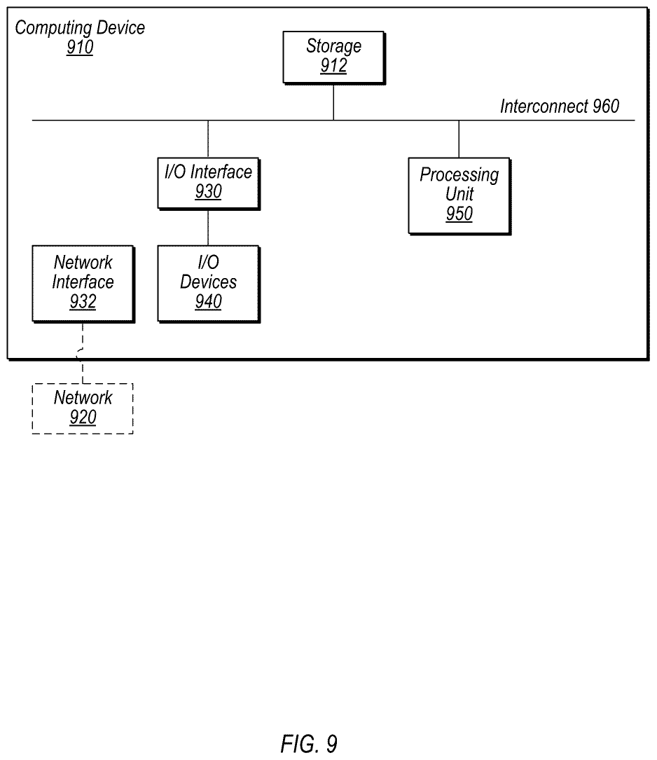

In the descriptions of FIGS. 1-8, various compute resources, client devices, and server computer systems have been disclosed. Such systems may be implemented in a variety of fashions. FIG. 9 provides an example of a computer system that may correspond to one or more of the disclosed compute resources, devices, and/or server computer systems.

### Example Computing Device

Turning now to FIG. 9, a block diagram of one embodiment of computing device (which may also be referred to as a computer system) 910 is depicted. Computing device 910 may be used to implement various portions of this disclosure including, for example, server computer system 101, client devices 150, and/or compute resources 105 and 125 in FIGS. 1-4. Computing device 910 may be any suitable type of device, including, but not limited to, a personal computer system, desktop computer, laptop or notebook computer, mainframe computer system, web server, workstation, or network computer. In some embodiments, computing device 910 may be implemented as a virtual computer system by one or more computers in a database system or server farm. As shown, computing device 910 includes processing unit 950, storage subsystem (storage) 912, and input/output (I/O) interface 930 coupled via an interconnect 960 (e.g., a system bus). I/O interface 930 may be coupled to one or more I/O devices 940. Computing device 910 further includes network interface 932, which may be coupled to network 920 for communicating with, for example, other computing devices.

In various embodiments, processing unit 950 includes one or more processors. In some embodiments, processing unit 950 includes one or more coprocessor units. In some embodiments, multiple instances of processing unit 950 may be coupled to interconnect 960. Processing unit 950 (or each processor within 950) may contain a cache or other form of on-board memory. In some embodiments, processing unit 950 may be implemented as a general-purpose processing unit, and in other embodiments it may be implemented as a special purpose processing unit (e.g., an ASIC). In general, computing device 910 is not limited to any particular type of processing unit or processor subsystem.

Storage subsystem 912 is usable by processing unit 950 (e.g., to store instructions executable by and data used by processing unit 950). Storage subsystem 912 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage subsystem 912 may consist solely of volatile memory, in one embodiment. Storage subsystem 912 may store program instructions executable by computing device 910 using processing unit 950, including program instructions executable to cause computing device 910 to implement the various techniques disclosed herein.

I/O interface 930 may represent one or more interfaces and may be any of various types of interfaces configured to couple to and communicate with other devices, according to various embodiments. In one embodiment, I/O interface 930 is a bridge chip from a front-side to one or more back-side buses. I/O interface 930 may be coupled to one or more I/O devices 940 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk), optical media (e.g., CD, DVD, and related technologies, etc.), or flash memory media (solid-state drives, USB memory sticks, etc.). The non-transitory computer-readable media may be either volatile or nonvolatile memory.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different elements (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

In this disclosure, various “modules” operable to perform designated functions may be shown in the figures and described in detail. As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A method, comprising:
receiving a request from a client device by an orchestrator process of a task processing system that is executing on a server computer system, wherein the orchestrator process is configured to process the request at least in part by causing a plurality of computing tasks to be performed;
distributing, by the orchestrator process, the plurality of computing tasks to a plurality of task queues;
assigning, by the orchestrator process, one or more compute resource pools to respective ones of the plurality of task queues, wherein a given compute resource pool includes processing circuitry and memory usable to perform computing task processing, and wherein the computing task processing includes processing a query portion of a query-response task in which the query portion of the query-response task is sent to a data store;
receiving, by the orchestrator process from the data store, a response to the query portion; and
adding, by the orchestrator process, a response portion of the query-response task to a particular task queue of the plurality of task queues for subsequent processing by a particular compute resource pool associated with the particular task queue.

2. The method of claim 1, wherein the given compute resource pool includes a plurality of compute resources, and wherein the query portion of the query-response task is performed by a first compute resource of the given compute resource pool.

3. The method of claim 2, further comprising:
retrieving, by a different compute resource of the given compute resource pool, the response portion of the query-response task from the particular task queue; and
completing, by the different compute resource, the query-response task by completing the response portion.

4. The method of claim 1, wherein adding the response portion of the query-response task to the respective task queue includes adding, by the orchestrator process, the response portion to a top of the particular task queue.

5. The method of claim 1, wherein distributing, the plurality of computing tasks to the plurality of task queues includes:
identifying, by the orchestrator process, a plurality of call tasks to a common database;
combining at least two of the identified call tasks into a single call task; and
placing the single call task into a particular one of the plurality of task queues.

6. The method of claim 1, wherein distributing, the plurality of computing tasks to the plurality of task queues includes:
identifying, by the orchestrator process, a plurality of call tasks to a common database; and
placing the identified call tasks into a particular one of the plurality of task queues.

7. The method of claim 1, further comprising:
allocating, by the orchestrator process, a first set of the compute resource pools to a first subset of the plurality of task queues, wherein the first subset is associated with a first type of client;
allocating, by the orchestrator process, a second set of the compute resource pools to a second subset of the plurality of task queues, wherein the second subset is associated with a second type of client; and
based on a comparison of a number of computing tasks in the first subset of task queues to a number of computing tasks in the second subset of task queues, reallocating, by the orchestrator process, a portion of the first set of the compute resource pools to the second set of the compute resource pools.

8. The method of claim 1, wherein a given compute resource is implemented as a central processing unit of a respective computer system included in a given server rack; and
wherein a given task queue is implemented as a data structure in one or more memory circuits of a memory system coupled to the given compute resource.

9. A non-transitory computer-readable medium having instructions stored thereon that are executable by a computer system to perform operations of an orchestrator process of a task processing system, the operations comprising:
determining a plurality of computing tasks for performing a request received from a client device;
placing the plurality of computing tasks into one or more of a plurality of task queues, wherein at least one of the plurality of computing tasks is a query-response task;
assigning ones of a plurality of compute resources to respective ones of the plurality of task queues;
receiving a response to a query portion of the query-response task, wherein a first compute resource of the plurality of compute resources processed the query portion;
adding a response portion of the query-response task to a given one of the plurality of task queues; and
receiving an indication that a second compute resource of the plurality of compute resources processed the response portion.

10. The non-transitory computer-readable medium of claim 9, wherein adding the response portion of the query-response task to the given task queue includes adding the response portion to a top of the given task queue.

11. The non-transitory computer-readable medium of claim 9, wherein placing the plurality of computing tasks into the one or more task queues includes:
identifying a plurality of call tasks that are calls to a common database; and
placing at least a portion of the plurality of call tasks into a common one of the plurality of task queues.

12. The non-transitory computer-readable medium of claim 11, wherein placing the at least a portion of the plurality of call tasks into the common task queue includes:
combining at least two of the identified call tasks into a single call task; and
placing the single call task into the common task queue.

13. The non-transitory computer-readable medium of claim 9, wherein assigning the ones of the compute resources to respective ones of the plurality of task queues includes:
allocating a first set of the compute resources to a first subset of the plurality of task queues, wherein the first subset is associated with a particular type of client; and
allocating a second set of the compute resources to a second subset of the plurality of task queues, wherein the second subset is associated with a different type of client.

14. The non-transitory computer-readable medium of claim 13, further comprising:
comparing a number of computing tasks in the first subset of task queues to a number of computing tasks in the second subset of task queues; and
reallocating, based on the comparing, the compute resources between the first and second subsets of task queues.

15. A server computer system comprising:
a plurality of compute resources, ones of the plurality of compute resources including one or more processors;
a memory system, including a plurality of memory circuits, having program instructions stored thereon that are executable by given processors of the plurality of compute resources to cause the server computer system to perform operations comprising:
receiving, by an orchestrator process performed by a first compute resource of the plurality of compute resources, a request from a client device, wherein processing the request includes performing a plurality of computing tasks;
distributing, by the orchestrator process, the plurality of computing tasks to a plurality of task queues stored in the memory system, including placing a query-response task of the plurality of computing tasks in a particular task queue;
retrieving, by a second compute resource of the plurality of compute resources, the query-response task from the particular task queue;
based on completing a query portion of the query-response task, retrieving, by the second compute resource, a next computing task from the particular task queue;
receiving, by the orchestrator process, a response to the query portion of the query-response task; and
adding, by the orchestrator process, a response portion of the query-response task to a given one of the plurality of task queues.

16. The server computer system of claim 15, wherein the operations further comprise:
retrieving, by a third compute resource of the plurality of compute resources, the response portion of the query-response task from the given task queue; and
completing the query-response task by performing the response portion.

17. The server computer system of claim 15, wherein the operations further comprise:
performing, by the second compute resource independent of the query-response task, the next computing task from the particular task queue.

18. The server computer system of claim 15, wherein distributing the plurality of computing tasks to the plurality of task queues includes:
identifying a plurality of call tasks that are calls to a common database; and
placing at least a portion of the plurality of call tasks into a common one of the plurality of task queues.

19. The server computer system of claim 18, wherein placing the at least a portion of the plurality of call tasks into the common task queue includes:
combining at least two of the identified call tasks into a single call task; and
placing the single call task into the common task queue.

20. The server computer system of claim 15, wherein the operations further comprise:
allocating, by the orchestrator process, a first set of the compute resources to a first subset of the plurality of task queues, wherein the first subset is associated with a particular type of client;
allocating, by the orchestrator process, a second set of the compute resources to a second subset of the plurality of task queues, wherein the second subset is associated with a different type of client; and
based on a comparison of a number of computing tasks in the first subset of task queues to a number of computing tasks in the second subset of task queues, redistributing, by the orchestrator process, the compute resources between the first and second subsets of task queues.
